(19) United States
(12) Patent Application Publication
(10) Pub. No.: US 2024/0197560 A1
(43) Pub. Date: Jun. 20, 2024

(54) VIBROACOUSTIC THERAPY DEVICE

(71) Applicant: Vibroacoustix LLC, La Conner, WA (US)

(72) Inventors: Louisa C. P. Firethorne, La Conner, WA (US); Rowan Helios Firethorne, La Conner, WA (US)

(73) Assignee: Vibroacoustix LLC, La Conner, WA (US)

(21) Appl. No.: 18/542,276

(22) Filed: Dec. 15, 2023

Related U.S. Application Data
(60) Provisional application No. 63/387,613, filed on Dec. 15, 2022.

(51) Int. Cl. A61H 23/02

(52) U.S. Cl. CPC A61H 23/0236; A61H 2201/0207; A61H 2201/1671; A61H 2201/5007; A61H 2201/5048; A61H 2201/5084; A61H 2203/0425; A61H 2203/0456; A61H 2203/0468

(57) ABSTRACT

A vibroacoustic therapy device uses a vibrational sound source to resonate with a body like a musical instrument that includes a person. The device is tuned to determine a fundamental resonant frequency with the body in connection with it. Then, applying vibroacoustic energy at different frequencies, the apparatus creates sensations of vibrational patterns within the body, comprised of areas of high vibration and relative stillness. The apparatus allows a person to physically feel modal vibrations within their own body. The vibroacoustic sensations are pleasant and may ease pain, enhance calm, and increase relaxation.

### CROSS-REFERENCE TO RELATED APPLICATIONS

This application claims the benefit of priority to U.S. provisional patent application No. 63/387,613, filed Dec. 15, 2022 in the name of The Sonosphere LLC (now Vibroacoustix LLC), titled “Vibroacoustic Therapy Device” and naming Louisa C. P. Firethorne and Rowan Helios Firethorne as inventors. The entire contents of the above-referenced application and all priority documents referenced in the Application Data Sheet filed herewith are hereby incorporated by reference for all purposes.

### FIELD

This disclosure is directed to improved systems and methods of vibroacoustic therapy.

### BACKGROUND

Traditional approaches to treatment with sound have been founded in wishful thinking or apparently magical “healing” properties wrapped in new-agey terminology. They have lacked engineering principles and scientific validity. They generally involve playing ambient or New Age music and common “sound bath” instruments such as crystal singing bowls and gongs to a person encouraged to relax on a feather bed or a massage table.

In the 1980s, vibroacoustic therapy began to investigate the effects of low-frequency sound vibrations. Conventional vibroacoustic devices include soft beds and chairs that embed speakers on or in padding like a mattress; molded back supports and flat wood DIY platforms to sit or lie against; and pillows, backpacks, paddles, handheld massagers, and wristbands to apply vibrations to specific body parts.

### BRIEF DESCRIPTION OF THE DRAWINGS

FIG. 1 illustrates a perspective view of components of an example vibroacoustic therapy apparatus in accordance with one embodiment.

FIG. 2 illustrates a realized vibroacoustic therapy apparatus in accordance with one embodiment.

FIG. 3 illustrates a person using a vibroacoustic therapy apparatus in accordance with one embodiment.

FIG. 4 illustrates a perspective view of a vibroacoustic therapy apparatus in accordance with one embodiment.

FIGS. 5A-5E are diagrams schematically illustrating a layout of tactile transducers of a vibroacoustic therapy apparatus in accordance with one embodiment.

FIG. 6 illustrates a perspective view of the underside of the platform of a vibroacoustic therapy apparatus in accordance with one embodiment.

FIG. 7 illustrates an operational routine of a vibroacoustic therapy apparatus in accordance with one embodiment.

FIG. 8 schematically illustrates components of a bottom connection joint in accordance with one embodiment.

FIG. 9 illustrates components of a bottom connection joint in accordance with one embodiment.

FIG. 10 schematically illustrates components of a top connection joint in accordance with one embodiment.

FIGS. 11A-11B illustrate aspects of silicone body pads in accordance with one embodiment.

FIG. 12 illustrates a perspective view of a person lying down on a vibroacoustic therapy apparatus in accordance with one embodiment.

FIG. 13 illustrates a perspective view of a person sitting upright on a vibroacoustic therapy apparatus in accordance with one embodiment.

FIG. 14 illustrates a workstation configured to operate a vibroacoustic therapy apparatus in accordance with one embodiment.

FIG. 15 is a block diagram showing some of the components typically incorporated in computing systems and other devices in connection with which the present technology can be implemented.

### DETAILED DESCRIPTION

This application discloses a vibroacoustic therapy device or apparatus suitable for stimulation of a body (e.g., a person) for sound therapy. It uses interval harmonic overtones and phase shifting frequencies to induce standing waves in a human body. In other terms, it is a person-sized cymatic instrument for resonating the human body in a harmonic way, using waves of tactile sound. Using spatial geometry, musical harmonics, and physics principles, the vibroacoustic therapy apparatus can be tuned or calibrated to an individual body in conjunction with a platform designed to deliver sonic and infrasonic energy. It provides a customized experience of sound throughout the whole body.

Cymatic vibration of a person's body is an entirely new concept of the inventor. It represents a confluence of art, science, and music. Rather than one big vibration, the experience is of thousands of tiny ripples, individual waves, swells of interference that make complex beat frequencies. A vibroacoustic therapy apparatus as disclosed herein uses a vibrational sound source to resonate a body like a musical instrument. Essentially, the body is inside a musical instrument, which is tuned to include the body as part of it. Then, applying vibroacoustic energy at different frequencies, geometric or organic patterns may be formed or felt within the body, comprised of areas that are either vibrating or are still (at “nodes”). Cymatic patterns are conventionally a visual representation of sound; the disclosed technology turns modal vibrations into phenomena that a person can physically feel within their own body.

Vibroacoustic energy is a term that describes acoustic and mechanical energy transmitted by sonic (audio) and infrasonic (vibrational) waves. Sound and lower-frequency vibrations are essentially mechanical waves in a medium, and physically can be described as oscillatory elastic compression and/or oscillatory displacement of the medium. The medium stores and transmits potential and kinetic energy as vibroacoustic waves pass through it. The medium can include air, a solid object (such as the platform of a vibroacoustic therapy device), and a human body. A person can experience vibroacoustic energy as applied tactile vibration.

Cymatic effects, patterns, and sensations are terms that refer to a person's experience of feeling vibroacoustic energy on or in their own body when positioned in, on, or in contact with the disclosed vibroacoustic therapy apparatus. For example, a person lying on a vibrating platform that is driven with vibroacoustic energy to vibrate in various vibrational modes can feel different parts of the platform, and their body, moving in sync with the applied vibroacoustic energy. Such cymatic sensations can include not just feeling the vibrating platform moving in relation to the person's body, but the person's body itself moving, with vibrations experienced least intensely at nodes where the amplitude of the vibrational system is lowest, and experienced most intensely in locations where the amplitude of the vibrational system is highest. Cymatic effects as disclosed herein differ from conventional uses of the term that refer to a third party observing patterns as visual representations of sound. Instead, cymatic effects, patterns, sensations, or experiences as disclosed and discussed herein are perceived on a first-person basis, e.g., proprioceptively, by a person using the disclosed vibroacoustic therapy apparatus. Thus, as used herein, cymatics refers to internal areas of increased vibratory sensation felt in the body.

The effects of the vibroacoustic therapy provided by the disclosed technology are therapeutic, educational, pleasant, and fun. Deaf subjects may find it provides a unique way to perceive and more fully enjoy music. The disclosed technology enables scientific exploration of sound-especially directed vibrations of low-frequency sound—as a therapy, opening the door to bring new validity to the field of ‘sound healing’ through careful study and experimentation in a controlled setting to produce reproducible results. The disclosed technology holds promise to aid some people in the therapeutic healing process for chronic pain, PTSD, anxiety, and more. However, it is not intended to treat or cure any disease or condition. A vibroacoustic therapy apparatus offers sensations that some people have found to ease pain, enhance calm, and increase relaxation—and that some people simply enjoy.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional sensing devices, or combinations of illustrated devices, may be added to, or combined, without limiting the scope to the embodiments disclosed herein. Each of the Figures discussed below may include many more or fewer components than those shown and described. Moreover, not all of the described components may be required to practice various embodiments, and variations in the arrangements and types of the components may be made. However, the components shown are sufficient to disclose various illustrative embodiments for practicing the disclosed technology.

While this disclosure generally refers to a vibroacoustic therapy device or vibroacoustic therapy apparatus, other terms may be equally applicable in various contexts. Such terms include cymatic resonance chamber (or instrument), sound chamber, cymatic massage device (or machine or apparatus), therapeutic sound spa, ambisonic sound system, and Sonosphere.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. As used in this specification and the appended claims, the singular forms “a,” “an,” and “the” include plural referents unless the content clearly dictates otherwise. For example, “a tactile transducer” generally includes multiple tactile transducers. It should also be noted that the term “or” is generally employed in its sense including “and/or” unless the content clearly dictates otherwise.

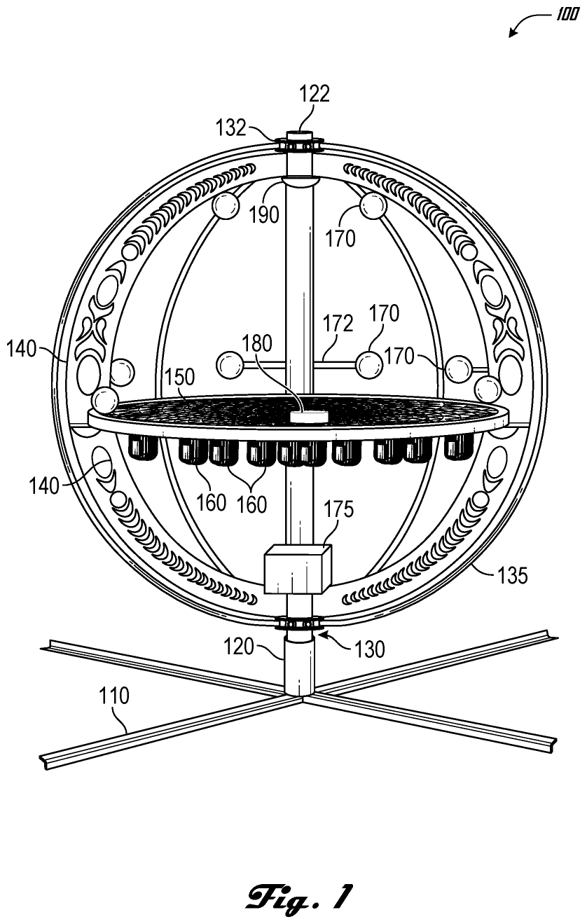

The disclosed vibroacoustic therapy apparatus can take a variety of form factors. FIGS. 1 through 15 illustrate a variety of different arrangements, designs, and subsystem possibilities. The illustrated cymatic systems and methods are not an exhaustive list; in other embodiments, a vibroacoustic therapy apparatus could be formed in different arrangements. However, it is not necessary to exhaustively show such optional implementation details to describe illustrative embodiments.

FIG. 1 illustrates a perspective view of components of an example vibroacoustic therapy apparatus 100 in accordance with one embodiment. The example vibroacoustic therapy apparatus 100 includes features such as:

Base: a base 110 provides stability to the vibroacoustic therapy apparatus 100. In the illustrated embodiment, the base 110 comprises four legs or feet that extend radially from beneath the center of the vibroacoustic therapy apparatus 100. Any configuration of the base 110 (e.g., any arrangement of legs or feet, or a base 110 without legs or feet, such as a circular or polygonal base) is contemplated. Embodiments without a spherical arrangement of rotatable arms may use other arrangements of legs or similar supports, such as supports extending from the frame members or points around the platform to the ground. In some embodiments, the vibroacoustic therapy apparatus 100 is suspended from above. A base 110 may support a stand, arch, or other mechanism from which the vibroacoustic therapy apparatus 100 is suspended; or, if the vibroacoustic therapy apparatus 100 is suspended from, for example, a ceiling beam, there may be no base 110. In some embodiments, the base 110 can incorporate steps or a ladder (which may be removable, movable, or retractable) to assist a person in getting onto the platform. Without loss of generality, this disclosure illustrates embodiments in which the vibroacoustic therapy apparatus 100 is supported on a central base 110.

Mount: a mount 120 or other support mechanism 120, such as a pole or pole stub surrounding or coincident with a central axis, e.g., a vertical axis. Other arrangements and axes are possible and contemplated; the inventor currently considers the illustrated example to be the best mode, but by no means the only possibility. The mount 120 or other support mechanism 120 is configured to support the platform 150 via at least one frame member 140, as described below. The mount 120 can include a passage for wiring that provides power, vibroacoustic signals, and/or control signals into the vibroacoustic therapy apparatus 100. Embodiments without a spherical arrangement of rotatable arms may be mounted or supported at more than one point.

The mount 120 or other support mechanism 120 may be arranged to support frame members 140 (e.g., support arcs as illustrated herein) from either end or both ends, such as support at opposite ends of a nonvertical central axis. In the illustrated embodiment, the frame arms form a second, top mount 122 at the top of the vibroacoustic therapy apparatus 100 to support a top hub 132.

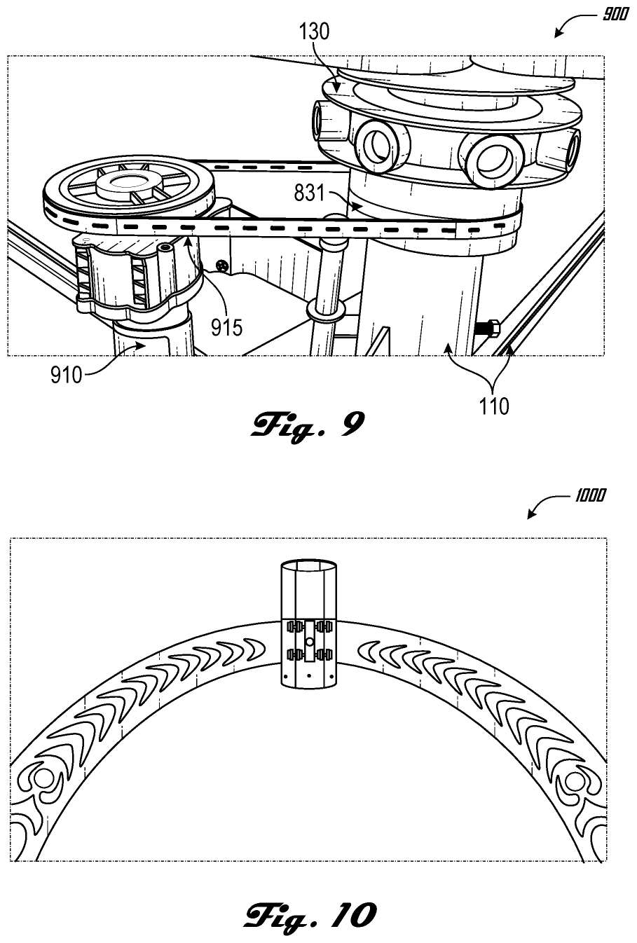

Hub: Optionally, a hub 130 is configured to attach, support, or rotate an element such as copper rotatable arms 135 around the mount 120 or other support mechanism 120. In an embodiment, the hub 130 is constructed of nylon or an equivalently low-friction material (e.g., a thermoplastic, polytetrafluoroethylene (PTFE), a lubricated metal, a magnetic bearing, etc.). In an embodiment, the hub 130 has a diameter of approximately three to eight inches, such as four inches or six inches. In some embodiments, the hub 130 includes commutators (e.g., 120V or 12V), such as for a motor to spin the rotatable arms 130 or to pass power from the exterior through to the interior of the vibroacoustic therapy apparatus 100. In some embodiments, a motor is mounted with a drive connection to the hub (e.g., gearing, a belt, a chain, a direct drive motor, etc.) to rotate the hub 130 and/or 132. An example motor with a belt drive connection to the hub 130 is illustrated in FIG. 9.

Rotating Arms: In the illustrated embodiment, the hub 130 is connected to a set of rotatable arms 135 formed of tubular copper that are configured to spin around the frame members 140 and platform 150 when the vibroacoustic therapy apparatus 100 is in operation, approximating a rotating sphere. The illustrated embodiment includes eight rotatable arms 135; in other embodiments, there may be more or fewer rotatable arms 135, and the rotatable arms 135 may be of different design and/or composition. In various embodiments, the rotating elements may include pipes (which may be connected by a membrane or fabric over the top, such as a copper mesh or other metallic mesh), a cage or solid spherical shell (with a door to enter and exit the vibroacoustic therapy apparatus 100, e.g., a “hamster ball” spherical arrangement), a cylinder arranged vertically and rotating around a horizontal axis (e.g., a “hamster wheel” arrangement), a cylinder arranged horizontally and rotating around a vertical axis, a cone or pyramidal arrangement of members, etc.

In the illustrated embodiment, the rotatable arms 135 provide a grounding path and copper touch points for, e.g., a person on the platform 150 to discharge any buildup of static electricity. In some embodiments, the rotatable arms 135 in rotation (and/or when stationary) approximate a copper sphere in real time or averaged over some time. Thus, the rotatable arms 135 can represent or function as a Helmholtz resonator, resonance caused by “wind throb,” like blowing over the top of a bottle to make a sound. This provides an additional layer of overtone harmonics to amplify the sounds within the chamber. In addition, the spherical effect of the rotatable arms 135 may act as a waveguide for vibroacoustic energy and/or an additional layer of resonance of the vibroacoustic therapy apparatus 100. For example, the rotatable arms 135 can keep sound waves inside the sphere and cut off reflected sound waves from outside the sphere that otherwise might bounce back into the chamber after reflecting off walls and surfaces in the surrounding environment. Additionally, the spinning of the sphere of the rotatable arms 135 provides a hypnotic visual focal point to soothe a busy mind and hold a person's attention (e.g., to occupy the “left brain”) so that the autonomic nervous system can take over, providing relaxing and rejuvenating relief.

In the illustrated example, the rotatable arms 135 are arranged to spin around a central vertical axis. In an alternative embodiment, an external support (e.g., the mount 120 or other support mechanism 120) can provide a hub 130 at one end or hubs 130, 132 at opposite ends of an axis of rotation, which can be a nonvertical axis such as a horizontal axis or a canted, tilted, adjustable, or nonstationary axis.

Frame members: At least one frame member 140 supports the platform 150. In the illustrated embodiment, the frame members 140 are support arcs that support the platform 150 from its edges and continue upward to define circumferences of a sphere. In the illustrated embodiment, there are four support arc frame members 140. Other configurations of frame members 140 (e.g., spiral arms, straight arms, a shell forming an enclosing section of a sphere, members forming a truss, etc.) in varying number are contemplated. In various embodiments, the platform 150 is supported at opposite edges, such as at four points around the edge of the platform 150. In other embodiments, the platform 150 is supported at a different number of points, such as at an odd number of points, which can be distributed evenly (e.g., equidistant around a circle) or unevenly. In another embodiment, the platform 150 is supported or suspended by a ring around its edge.

In the illustrated embodiment, the frame members 140 are support arcs constructed as hollow beams, each having a maximum dimension of approximately 9 inches by three inches. In some embodiments, the hollow support arcs function as resonant frame members 140 that reinforce various sound frequencies to enhance an ambisonic experience; in some embodiments, the resonant frame members 140 may be tunable or pre-tuned. In various embodiments, the frame members 140 are constructed of aluminum, steel, or other metals; acrylic, polycarbonate, or other plastics; or wood or other composite materials. In some embodiments, the frame members 140 are solid. In the illustrated embodiment, the frame members 140 include a decorative pattern of holes that lighten the frame members 140 and allow colored lighting effects that enhance a visual appeal of the vibroacoustic therapy apparatus 100. In an embodiment, the frame members 140 are configured to vibrate at one or more frequencies in conjunction with or sympathetic to the platform 150.

Platform: The platform 150 supports a body (shown in following illustrations) and is configured to vibrate and pass those vibrations into a body on the platform 150 when vibroacoustic energy is applied to the platform 150. The platform 150 is preferably supported from its edge(s). This allows the entire platform 150 to freely vibrate in different modes and produce cymatic effects that can be tuned in conjunction with a body in contact with the platform 150. In some embodiments, the platform 150 is not rigidly fastened to other parts of the vibroacoustic therapy device, leaving the entire platform 150 free to vibrate in many normal modes, some of which could be damped by rigid connections (e.g., attachment along an edge). In some embodiments, the platform 150 is supported on or hung from a resilient connection (e.g., a sprung support point, pad, hook, or fastener) that allows the platform 150 to move freely when vibroacoustic energy is applied to it. The platform 150 is configured to be responsive to vibroacoustic energy and to freely allow, transmit, and resonate (e.g., be excited into standing waves) at various natural frequencies or normal modes.

In an embodiment, the platform 150 is formed or constructed from acrylic material. Acrylic is poly(methyl methacrylate) (PMMA), a synthetic polymer and transparent thermoplastic, available under brands such as Plexiglas® and Lucite®. The inventor has discovered various advantages of a rigid acrylic platform 150 of the disclosed size (diameter and thickness) including desirable vibrational characteristics, acceptable weight, and light transmissivity (including the ability to enhance a user's experience by applying lighting effects through clear and/or translucent (e.g., frosted or roughened) portions of the platform 150). In other embodiments, the platform 150 is formed or constructed from polycarbonate, aluminum, steel, wood (e.g., engineered wood such as plywood, or solid wood), glass, a taut membrane (e.g., a suitably sturdy woven or sheet material, suspended akin to a net or a drumhead), composite materials such as fiber-reinforced plastic (e.g., fiberglass or carbon fiber) which may include layers around a core, or other materials having sufficient strength to support a body and having appropriate vibrational or resonant characteristics. Other materials would require different thicknesses, tuning, and/or other adaptations to perform well in a vibroacoustic therapy device 100. For example, wood absorbs vibrations more readily than acrylic. In contrast, steel and aluminum are generally stiffer and naturally vibrate at higher frequencies, which would produce different overtone harmonics. The inventor has determined that a one-inch-thick acrylic platform 150 provides sufficient strength and desirable resonant characteristics.

In various embodiments, the platform 150 is generally circular in plan form. Understanding that sound waves propagate in a circular fashion, the inventor has determined that a generally circular shape is the most effective and preferred plan form for the platform 150. Advantages of a circular platform 150 include symmetry for determining resonances and applying different vibrational modes, a shape that permits elements such as the rotatable arms 135 to rotate around and in proximity to the platform, compatibility with a spherical form of the vibroacoustic therapy apparatus 100 (as well as alternative forms such as cylindrical, conical, etc.), and omnidirectionality or symmetry that can simplify construction and operation of the vibroacoustic therapy apparatus 100.

In some embodiments, the platform 150 has a perimeter or plan form that is only approximately circular or is noncircular. For example, a multifaceted platform might be hexagonal, octagonal, nonagonal, dodecagonal, or icosagonal (including, e.g., a star polygon); the shape may include various (and varying) internal angles and edge lengths. Other configurations of the platform 150 can produce different vibrational modes in conjunction with adjusted or entirely different tactile transducer arrangements. In various embodiments, the platform 150 has a curved plan shape, allowing the platform 150 to be circular, elliptical, oval or ovoid, or lobed; for example, a platform 150 could be designed longer in one dimension than in a perpendicular dimension to conform more closely to the taller-than-wide proportions of a person's body (e.g., of an average or maximum expected size). In other embodiments the platform 150 can include angles or straight lines, allowing the platform 150 to be polygonal (regular or irregular), a rounded rectangle, or another shape. In some embodiments, the platform 150 is partly or wholly non-flat, including one or more features such as a dome, a dish, or a shaped indentation having proportions of or related to a person's body (e.g., an average body size).

In an embodiment, the dimensions of the platform 150 are approximately one inch thick and approximately 79 inches (roughly six to seven feet or two meters) in diameter, which is sufficient to accommodate a wide variety of body sizes (e.g., a person lying in the center of the platform 150). In various embodiments, a thickness of the platform 150 ranges from a flexible membrane around a millimeter or less thick to a solid surface from approximately a sixteenth of an inch to approximately three inches thick. In some embodiments, a thickness of the platform 150 varies across the platform 150. In various embodiments, a diameter (or other height or width dimension) of the platform 150 ranges from approximately 60 inches to approximately 100 inches. Other dimensions are contemplated as well, such as a smaller platform 150 configured to accommodate smaller bodies (e.g., children or pets) or a person in a seated, standing, or other non-prone position, or a larger platform configured to accommodate, e.g., multiple bodies. In some embodiments, the platform 150 is constructed of multiple smaller parts that can be disassembled, transported, and reassembled. Such parts can then be locked together (e.g., with latches, pins, and/or interlocking shapes) to vibrate as one unit.

Tactile transducers: A tactile transducer 160 (also referred to as a bass transducer) is a driver that sends sonic vibrations through the material to which it is attached, typically producing low-frequency sound and/or infrasonic or sub-aural vibration. For example, a tactile transducer 160 may be rated for a frequency response from a high end of around 100 hertz (Hz) (a low bass note) down to a low end of 5 Hz or lower (a vibration that is below a typical range of human hearing). Traditional audio speakers produce sound waves in the air that people perceive through the ears. In contrast, a tactile transducer 160 produces “tactile sound,” a haptic sensation of vibrational sound energy that is transmitted by direct contact to a body. Typically, a person can feel such vibrations-both at low audible frequencies and at inaudible infrasonic frequencies-through the skin, through muscles and/or deep tissue, and/or through bone conduction.

In various embodiments, one or more tactile transducers 160 are affixed to the platform. The tactile transducers 160 may include an inertial shaker that vibrates a mass and transmits that vibration to the platform, and/or a linear actuator that directly pushes (and/or pulls) the platform relative to a heavy or fixed point or surface such as the base 110 of the vibroacoustic therapy apparatus 100. In the illustrated embodiment, ten inertial shaker tactile transducers 160 are affixed to the underside of the platform 150. In the illustrated embodiment, each tactile transducer 160 is a ButtKicker® R low frequency audio transducer (produced by The Guitammer Company Inc. of Westerville, OH) rated to handle at least 450 watts of input power to produce vibroacoustic waves. Thus, in combination, the illustrated ten tactile transducers 160 are configured to apply around 4,500 watts or more of vibroacoustic power to vibrate the illustrated vibroacoustic therapy apparatus 100. That is significantly more power than conventional vibroacoustic devices, and allows the illustrated vibroacoustic therapy apparatus 100 to produce significantly different cymatic effects than conventional vibroacoustic devices. In other embodiments, tactile transducers 160 are affixed in different numbers, sizes, powers, types, and/or locations suitable to produce cymatic effects. For example, some tactile transducers 160 may have different frequency response characteristics. As another example, some tactile transducers 160 may be located on a top surface of the platform 150, or embedded in the platform 150.

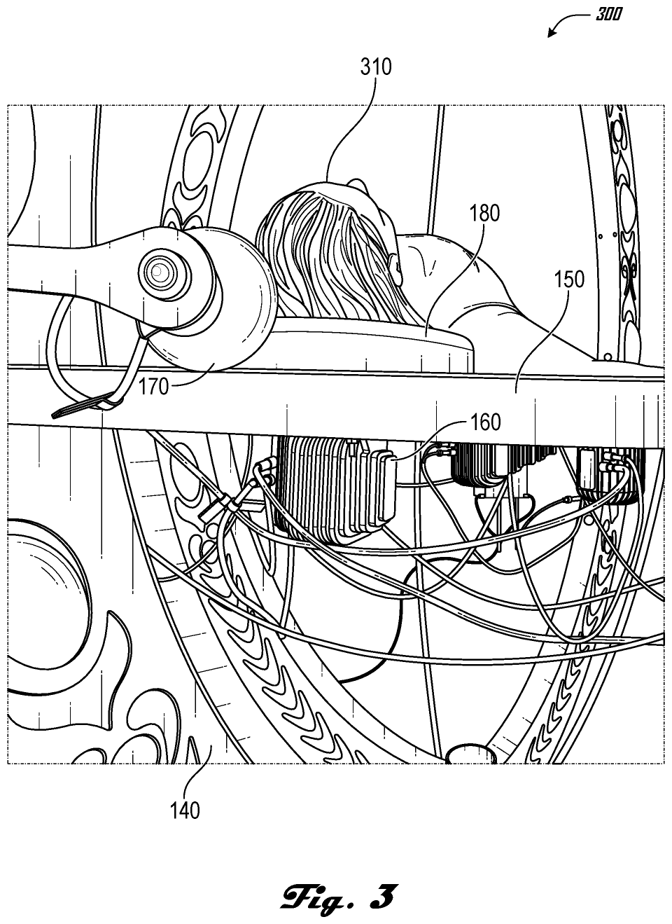

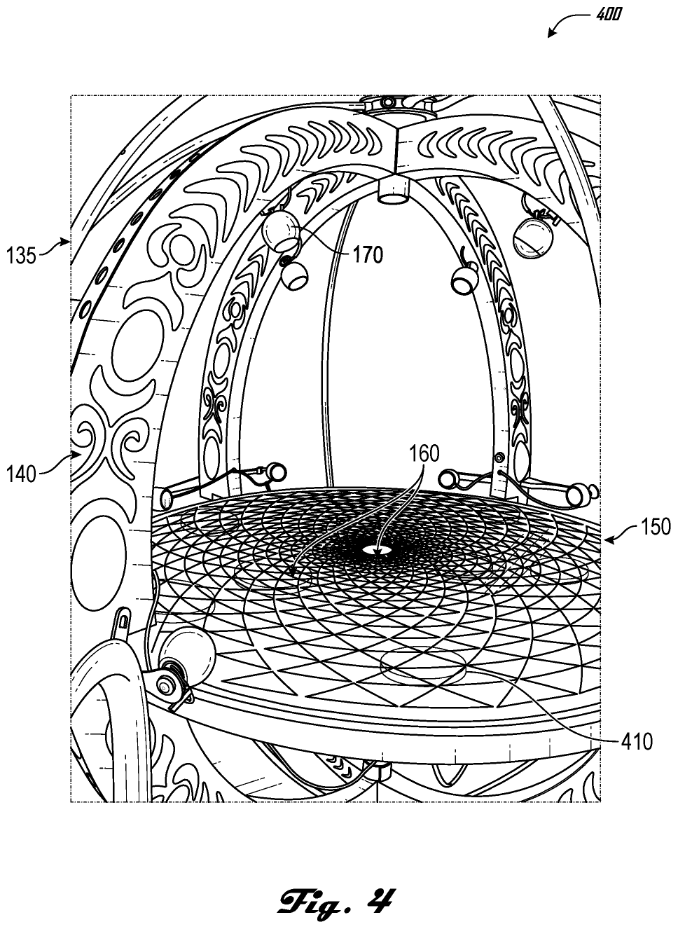

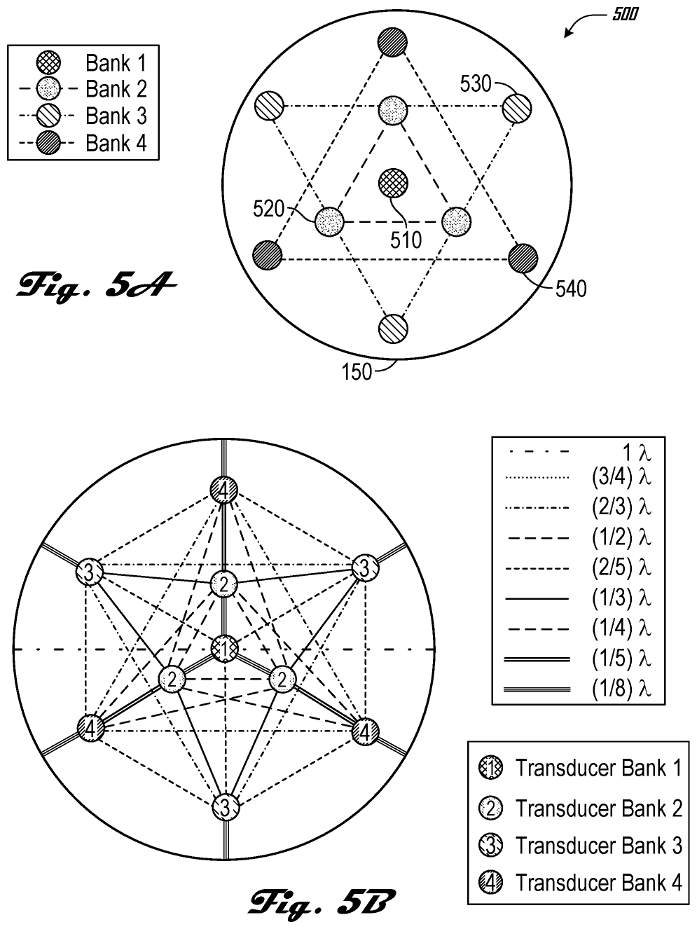

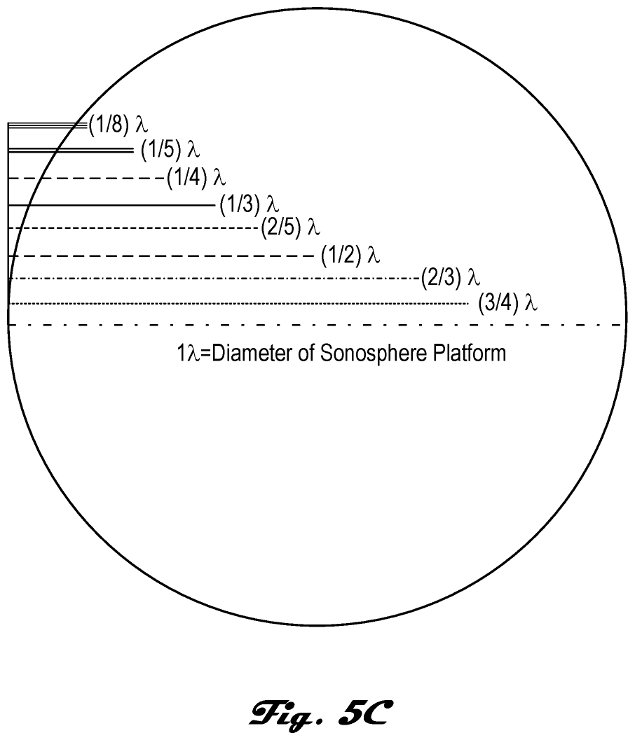

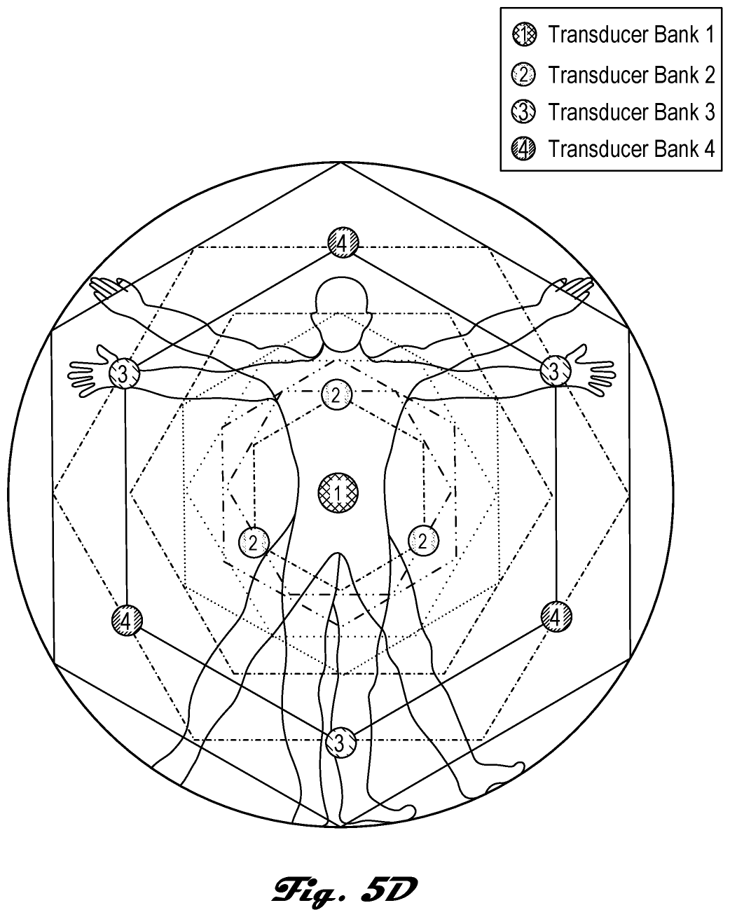

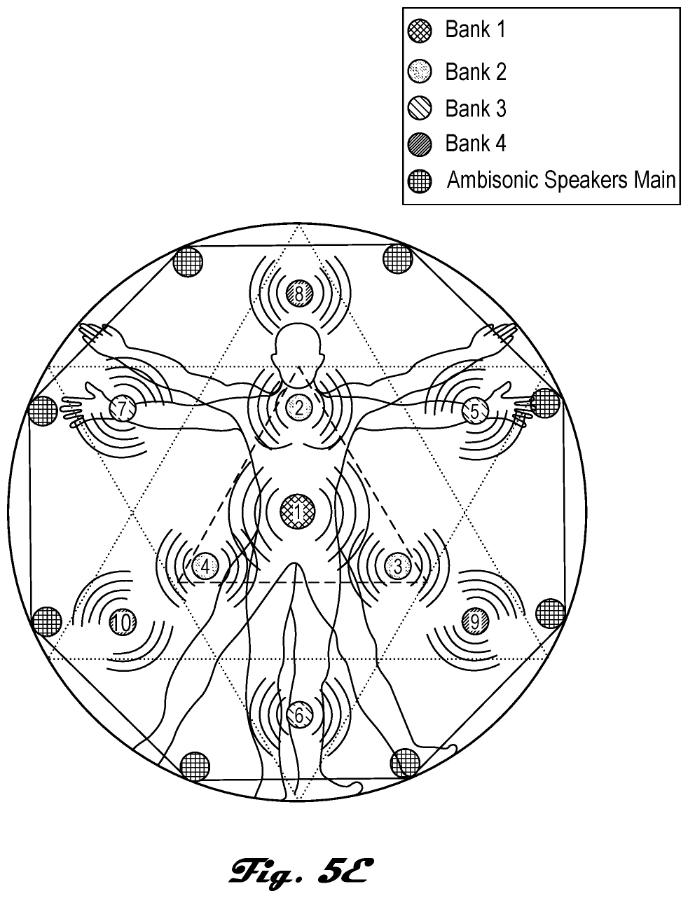

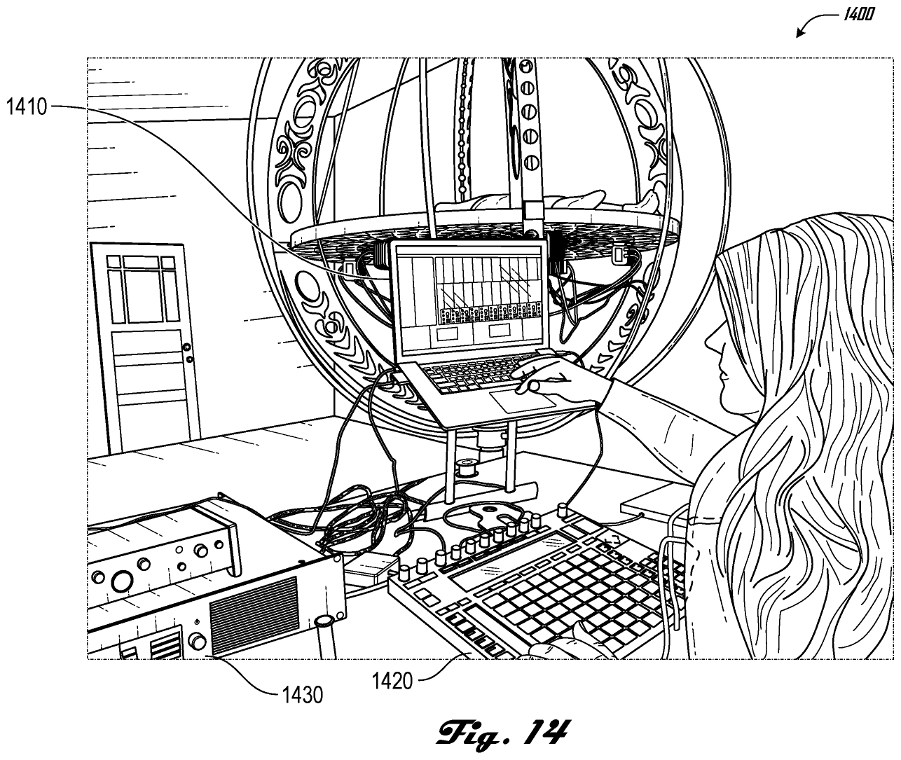

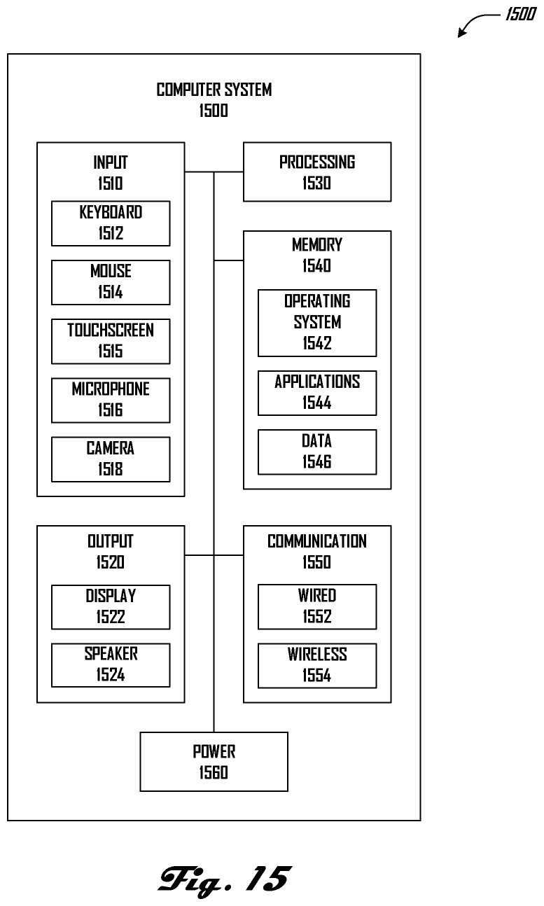

In the illustrated embodiment, tactile transducers 160 are arranged in a concentric pattern. In various embodiments, the tactile transducers 160 can be arranged in a manner that allows an operator to tune resonances and produce different vibration effects and/or vibrational modes by controlling the activation of different tactile transducers 160 and by controlling the levels and frequencies of signals delivered to different tactile transducers 160. An arrangement of the tactile transducers 160 is described in greater detail below with reference to FIGS. 5A-5E. Control of the tactile transducers 160 is described in greater detail below with reference to FIGS. 14-15.

Speakers: To enhance and complement the vibroacoustic sensations generated by the tactile transducers 160, audio speakers 170 can generate sound energy at higher frequencies, transmitted through the air and perceived audibly. For example, speakers 170 may produce overtones of a fundamental tone produced by a tactile transducer 160. Each or all of the speakers 170 may be configured to produce a wide range of frequencies or narrow bands of tones. For example, speakers 170 can include one or more subwoofers 175 designed to produce bass down to about 30 Hz, and/or woofers, tweeters, or other types of speakers designed to produce midrange and treble tones up to thousands of hertz. The speakers 170 are configured to produce ambisonic audio energy played in sync with the tactile energy produced by the tactile transducers 160.

Speakers 170 can be arranged above, below, in, and/or around the platform 150 or a user of the vibroacoustic therapy apparatus 100. In the illustrated example, spherical speakers 170 are mounted on holder arms 172 that follow the curvature of the platform 150 and are attached to the frame members 140. In the illustrated arrangement, eight speakers 170 are mounted equidistant from each other around the edge of the platform 150. In addition, four spherical speakers 170 are suspended from the frame members 140 above the platform 150, and a subwoofer 175 below the platform 150 (which may be located on the floor with the base 110) blends low-frequency audio with the vibrations from the tactile transducers 160. Thus, the speakers 170 can be arranged to produce “12.1” full-sphere surround sound. Other speaker 170 arrangements are possible and contemplated. For example, in some embodiments, the audio speakers 170 are located around the user's head, such as by headphones or earbuds connected (by wires or wirelessly) to the vibroacoustic therapy apparatus 100. In some embodiments, speakers 170 implemented as headphones or earbuds or other sound-producing devices connected to the user's head or body can include binaural speakers or be configured to detect a position of the user's head or body to effectively produce sounds that are coordinated to enhance and complement the vibroacoustic sensations generated by the tactile transducers 160.

In some multi-speaker 170 embodiments, rather than transmitting multichannel surround sound in a format that provides signals for “left,” “right,” and surround channels (including, e.g., above and below), the vibroacoustic therapy apparatus 100 uses a speaker-independent representation of a sound field called B-format that is decoded to the speaker 170 setup of the vibroacoustic therapy apparatus 100. That allows sounds to be generated in terms of source directions rather than loudspeaker positions, and offers enhanced flexibility regarding the layout and number of speakers 170 used in the vibroacoustic therapy apparatus 100, creating an ambisonic sound environment.

Pads: Body pads 180 improve a person's experience in the vibroacoustic therapy apparatus 100. The platform 150 includes a hard flat surface that is vibrating with many frequencies. A person sitting or lying on the platform 150 may experience those vibrations at levels varying from subtle to intense. Vibration of a hard surface, especially intense vibration, may be uncomfortable against some body parts, such as a user's skull, hips, and joints (e.g., knees, elbows, and/or knuckles). To provide comfort to the person using the vibroacoustic therapy apparatus 100, the body pads 180 cushion body parts that might not have natural padding. In various embodiments, the body pads 180 are movable, provided in different sizes and thicknesses, and can be placed appropriately to fit the body dimensions of each user and to allow the user to be centered or otherwise properly positioned for experiencing resonant effects of the vibroacoustic therapy apparatus 100. In some embodiments, the body pads 180 cover all or a large portion of the platform 150, forming a layer on top of the platform 150.

The inventor determined that materials such as cotton, memory foam, and others commonly used to provide padding or comfort also absorb vibrations. Such materials would therefore be undesirable as body pads 180 in the vibroacoustic therapy apparatus 100. The inventor determined that jelly-like silicone transmits vibrations, making it an acceptable material. In various embodiments, the body pads 180 are formed from a silicone gel. The gel material may be chosen for various characteristics including a level of stiffness or softness to most efficiently transmit vibrations produced by the tactile transducers 160. In some embodiments, the body pads 180 are formed or molded from two or more layers or kinds of silicone gel or other materials. For example, body pads 180 may include an internal layer or filling of very soft silicone gel that is sticky to the touch, and a protective external encapsulating layer or shell that is soft but not sticky. This allows body pads 180 to have maximal transmissivity and cushioning provided by the internal layer, and a simply handleable, user-friendly, and easy-to-clean exterior.

Heat source: In some embodiments, the vibroacoustic therapy apparatus 100 includes a heat source 190. In the illustrated embodiment, the heat source 190 is a central radiant heat lamp that warms the platform and the body pads prior to use, to improve comfort for the person using the vibroacoustic therapy apparatus 100. In some embodiments, a heat source 190 in one or more of the body pads 180 or in or under the platform 150 warms the body pads 180 and/or the platform 150. In some embodiments, the heat source 190 is a heating pad on the platform 150, e.g., lying below the body on the platform 150.

The following figures illustrate additional elements associated with the vibroacoustic therapy apparatus 100. For example, the tactile transducers 160 and the speakers 170 are fed vibroacoustic and/or audio signals through one or more amplifiers, and the operation of the vibroacoustic therapy apparatus 100 is controlled by a control station or workstation such as a computing device or audio mixing interface, as described in further detail herein.

The present disclosure encompasses various arrangements and shapes of vibroacoustic therapy devices, and is not limited to the embodiment described via this illustrative example.

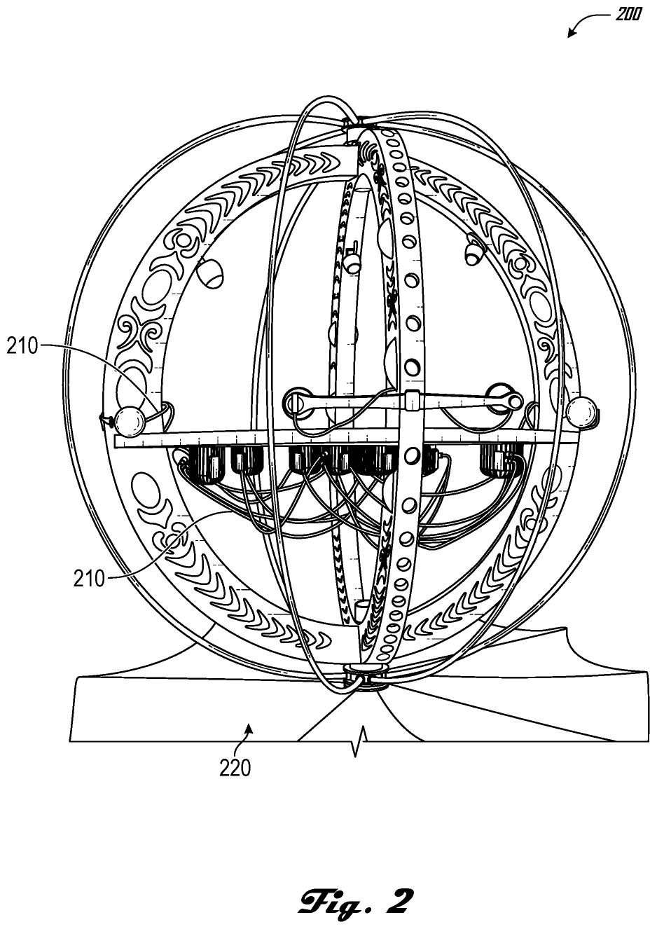

FIG. 2 illustrates a realized vibroacoustic therapy apparatus 200 in accordance with one embodiment. The illustrated vibroacoustic therapy apparatus 200 is constructed substantially in accordance with FIG. 1. In addition to the elements described above with reference to FIG. 1, the photograph 200 illustrates wiring 210 that feeds signals to the tactile transducers 160 and the speakers 170, and a skirt 220 including fabric suspended over ribs. The skirt 220 hides the base 110 in a way that is visually appealing and establishes a perimeter around the vibroacoustic therapy apparatus 200. In various embodiments, the wiring 210 is affixed or built into the vibroacoustic therapy apparatus 100 (e.g., in or on the platform 150 or frame members 140), reducing visual clutter to avoid distracting a person from the experience of using the vibroacoustic therapy apparatus 100.

FIG. 3 illustrates a person using a vibroacoustic therapy apparatus 300 in accordance with one embodiment. The illustrated vibroacoustic therapy apparatus 300 is constructed substantially in accordance with FIG. 1. The user 310 is lying on the platform 150, which is supported by the frame members 140. The user 310 rests their head on a body pad 180 for comfort. The placement of the body pad 180 puts the head of the user 310 above a tactile transducer 160 and near a speaker 170 for an ambisonic cymatic experience in the vibroacoustic therapy apparatus 300.

FIG. 4 illustrates a perspective view of a vibroacoustic therapy apparatus 400 in accordance with one embodiment. The illustrated vibroacoustic therapy apparatus 400 is constructed substantially in accordance with FIG. 1. The perspective view shows a top surface of the platform 150, which is supported by the frame members 140. The platform 150 includes clear and translucent portions. Visible through the platform 150 are mounting plates 410 to which the tactile transducers 160 are affixed. Upper speakers 170 are also visible.

FIGS. 5A-5E are diagrams schematically illustrating a layout 500 of tactile transducers 160 of a vibroacoustic therapy apparatus in accordance with one embodiment. FIG. 5A illustrates the layout 500 in nested triangles. In the illustrated layout 500, the tactile transducers 160 are arranged in four banks 510, 520, 530, 540. The first bank 510 is a single tactile transducer 160 located approximately in the center of the platform 150. Each of the other three banks 520, 530, 540 includes three tactile transducers 160 arranged in an equilateral triangle centered on the center tactile transducer of the first bank 510.

The second bank 520 and the third bank 530 are arranged such that the tactile transducers 160 of the second bank 520 lie at the midpoints of the sides of the triangle formed by the tactile transducers 160 of the third bank 530; in other words, the second bank 520 is a medial triangle (a similar inscribed triangle) of the third bank 530. Accordingly, the tactile transducers 160 of the second bank 520 and the third bank 530 are all equidistant from their nearest neighbor tactile transducers 160 of the second bank 520 and the third bank 530.

The fourth bank 540 is arranged in a triangle oriented 180 degrees from the third bank 530 and at the same distance from the center of the platform 150 and the single tactile transducer 160 of the first bank 510 as the tactile transducers 160 of the third bank 530. Thus, the tactile transducers 160 of the fourth bank 540 and the tactile transducers 160 of the third bank 530 form an outer hexagon (approximating a ring or circle) of six tactile transducers 160 surrounding an inner triangle of three tactile transducers 160 surrounding one central tactile transducer 160. The tactile transducers 160 of the first bank 510, the second bank 520, and the fourth bank 540 form three radial lines in which the distance from the central tactile transducer 160 of the first bank 510 to the tactile transducers 160 of the second bank 520 is equal to the distance from the tactile transducers 160 of the second bank 520 to the tactile transducers 160 of the fourth bank 540.

FIG. 5B illustrates the layout 500 using lambda relationships as another approach. In the illustrated layout 500, lambda represents a vibratory diameter of the vibroacoustic therapy apparatus, such as the diameter of a free-to-vibrate substantially circular platform 150 as described above with reference to FIG. 1. The transducers are arranged in a geometric pattern that spaces each transducer from various other transducers—of its own transducer bank and adjacent banks-according to lambda fractions. FIG. 5C visually illustrates the lambda fractions utilized in this example. From smallest to largest, the fractions are ⅛, ⅕, ¼, ⅓, ⅖, ½, ⅔, ¾, and 1. These lambda fractions are simple fractions using small numbers; in other words, they are ratios or fractional multiples composed of whole integers. Other fractions may be used; these ratios are provided for illustrative purposes. These lambda fraction relationships can be used to tune transducers and transducer banks relative to one another to more effectively generate vibrational modes that a user can experience as cymatic effects.

Returning to FIG. 5B, the tactile transducers are arranged in four banks, as in the layout 500 of FIG. 5A. The figure illustrates various whole integer fractions or divisions of one lambda (diameter) as potential distances between transducers. In various embodiments, the transducers may be laid out according to one or more sets of lambda relationships. Not all the illustrated lambda relationships can necessarily hold true at the same time; FIG. 5B shows various possible relationships superimposed upon each other. For example, spacing between the transducers of Bank 3 and Bank 4 can be ⅔ lambda, and spacing between the transducers of Bank 2 and Bank 3 can be ⅓ lambda, but spacing among the transducers of Bank 2 cannot then be ¼ lambda while the transducers are mounted in the same plane. However, the tactile transducers 160 are not point objects; they have nonzero widths (of, e.g., their voice coils or other drivers, their housings that respond to the drivers, their footings, and any mounting pads 410 by which they may be affixed to the platform 150). As a result, in various embodiments, even where distances are not precise, approximated relationships and the non-point nature of the transducers can allow the vibroacoustic therapy apparatus to nevertheless produce vibrations that take advantage of geometric relationships and/or lambda fractions to effectively generate modal vibrations.

FIG. 5D illustrates an alternative approach to laying out transducers in a similar format. The illustrated approach inscribes, within the outline of the vibratory platform 150, a large regular hexagon. A smaller hexagon is nested within the outer hexagon, rotated thirty degrees so that each vertex of the smaller inscribed hexagon is located at the midpoint of a side of the larger hexagon. Several successively smaller hexagons are thus inscribed. Transducers may be located, according to this inscribed hexagons approach, at hexagon vertices and at the center of the circle.

FIG. 5E illustrates a layout of tactile transducers 160 in banks as described above, showing how vibrations from the tactile transducers 160 may interact with a human body lying on the platform. In addition, the illustrated layout includes ambisonic audio speakers 170 arranged at edges of the platform 150 in an octagonal arrangement, illustrating the use of additional geometric patterns.

The inventor has determined that the disclosed arrangement of tactile transducers allows effective creation of cymatic patterns or the perception of a cymatic experience in a vibroacoustic therapy apparatus, and that the relationships between the banks of tactile transducers allows for effective control of vibroacoustic energy, to produce modes of vibration in the platform 150 and a body on the platform 150. For example, an operator can use the different banks of tactile transducers 160 to generate harmonically related frequencies in each bank 510, 520, 530, 540. Some banks can generate vibrations at the same frequency; others can apply vibrations in harmonics or at intervals such as octaves or thirds. This generates an interference pattern that cancels and amplifies waves at different locations based on the chosen frequencies and the tuning of the vibroacoustic therapy apparatus to the platform 150 including a person on the platform 150. Various arrangements of transducers 160 (and tuning of audio signals sent to the transducers 160) can also create effects such as beat frequencies (additive or subtractive signals akin to heterodynes).

The layout 500 of tactile transducers 160 illustrated in FIGS. 5A-5E are just two possible arrangements. The present disclosure encompasses various arrangements and layouts of transducers 160, and is not limited to the embodiment described via this illustrative example. For example, in some embodiments, transducers 160 are arranged in rows on either side of a person's body (e.g., on either side of a space configured for the user 310 of FIG. 3). In some embodiments, transducers 160 are laid out in another polygonal pattern (including, e.g., nested polygons), or in a spiral, golden ratio, or Fibonacci arrangement. Such layouts and variations on them are contemplated by and within the scope of the present disclosure.

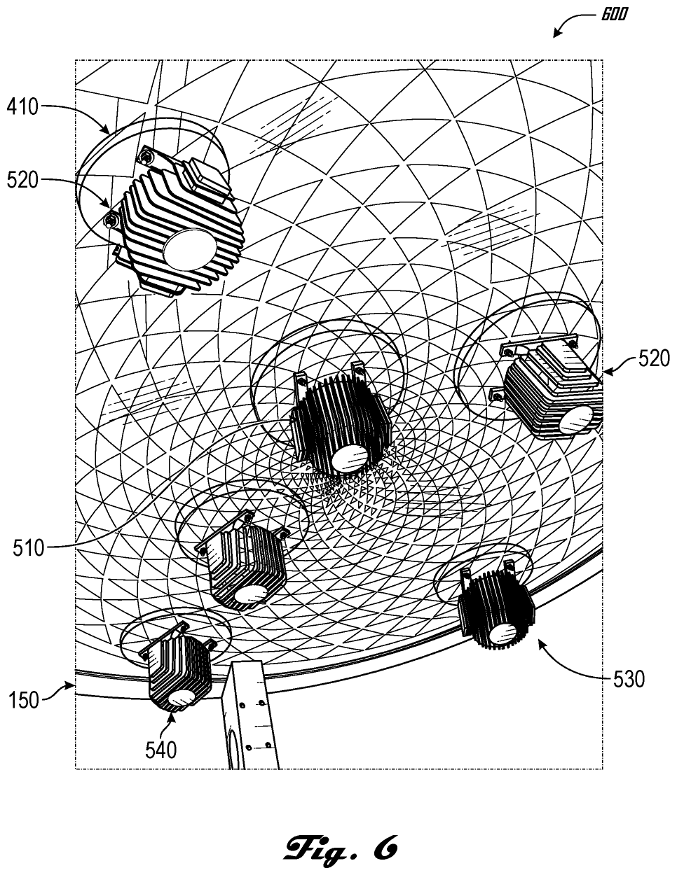

FIG. 6 illustrates a perspective view of the underside of the platform 150 of a vibroacoustic therapy apparatus 600 in accordance with one embodiment. The tactile transducers 160 affixed to the platform 150 are arranged substantially in accordance with FIG. 5A. The perspective view shows a bottom surface of the platform 150. Attached to the underside of the platform 150 are clear mounting plates to which the tactile transducers 160 are affixed. Tactile transducers 160 of the first bank 510, the second bank 520, the third bank 530, and the fourth bank 540 are illustrated.

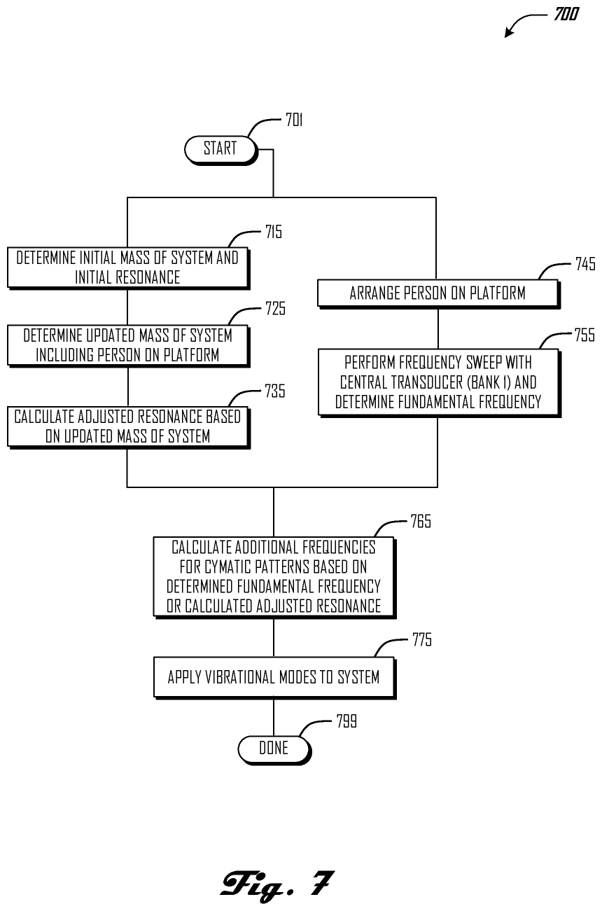

FIG. 7 illustrates an operational routine 700 of a vibroacoustic therapy apparatus in accordance with one embodiment. In various embodiments, the operational routine 700 is performed by one or more computing devices such as those illustrated below with reference to FIGS. 14-15. As those having ordinary skill in the art will recognize, not all events of an operational routine are illustrated in FIG. 7. Rather, for clarity, only those aspects reasonably relevant to describing the application of vibroacoustic energy to a person are shown and described. Those having ordinary skill in the art will also recognize that the presented embodiment is merely one example embodiment and that variations on the presented embodiment may be made without departing from the scope of the broader inventive concept set forth in the description herein and the claims below. The operational routine 700 begins in starting block 701.

The illustrated operational routine 700 branches to show two alternative approaches to determine a resonant frequency. One branch includes blocks 715, 725, and 735; the other branch includes blocks 745 and 755. Various implementations of a vibroacoustic therapy apparatus may utilize either approach, or combinations or permutations thereof.

Turning to the approach illustrated in blocks 715, 725, and 735: in block 715, the operational routine 700 determines an initial mass of the vibratory system of the vibroacoustic therapy apparatus, and an initial resonance. For example, the platform 150 of FIG. 1, together with the tactile transducers 160 and their mounting hardware, have a determinable mass. In some embodiments, the vibroacoustic therapy apparatus includes a scale, strain gauge, or other sensor usable to determine a mass of the portion of the vibroacoustic therapy apparatus that is designed to vibrate—and resonate. In various embodiments, the initial vibrational system has a resonance or a resonant peak at approximately 40 Hz, representing a fundamental frequency of the vibroacoustic therapy apparatus.

In block 725, the operational routine 700 determines an updated mass of the vibratory system of the vibroacoustic therapy apparatus including a body (e.g., a person) on the platform 150. For example, the operational routine 700 may use a scale reading (or an estimated weight value) to determine a mass of the body being added to the initial system, and calculate the sum of the mass being added and the initial mass. Alternatively, if the vibroacoustic therapy apparatus includes the scale, strain gauge, or other sensor usable to determine a mass, the operational routine 700 may determine the combined mass when the body is on the platform 150 by remeasuring the mass of the system.

In block 735, the operational routine 700 calculates an adjusted resonance based on the updated mass of the system. Modes of resonance have a determinable relationship to the mass of the system. Frequencies that are known to cause resonance in the system's initial state may not cause resonance in the system's updated state with additional mass. In general, for the purposes of calibrating the vibroacoustic therapy apparatus, the relationship between resonance and mass is linear. Most bodies are in a range of density, size, and distribution of mass that such secondary factors do not need to be carefully accounted for to calibrate the system to an effective level of performance. In various embodiments, the adjusted resonance or resonant peak of the vibrational system including a human body is around approximately 37-42 Hz, representing a fundamental frequency of the vibroacoustic therapy apparatus with a user.

Turning to the approach of blocks 745 and 755: in block 745, the person (including, e.g., more than one person as applicable) is arranged in the desired position on the platform.

In block 755, the operational routine 700 performs a frequency sweep with the central tactile transducer 160 of the first bank 510 and determines a fundamental frequency. For example, in a system as described herein, the tactile transducer 160 produces tones from approximately 15 Hz to approximately 50-100 Hz. At the resonant peak frequency, vibrations of the system become much stronger. A sensor such as an accelerometer or a microphone (or, e.g., a microphone array) and a real-time acoustic spectral analysis tool (e.g., software operating on a computing device such as the computer system 1500) can be used to determine the resonant peak of the system (including the platform 150 and the body on the platform 150). In some embodiments, one microphone is located above the platform 150 and a second microphone is located below the platform 150. When a body and the platform are in resonance together, the person experiences a pleasing sensation.

In block 765, the operational routine 700 calculates additional frequencies to produce cymatic sensations in the human body based on the fundamental frequency determined in block 755 and/or the adjusted resonance calculated in block 735. When the fundamental frequency is identified, additional modes of vibration can be applied by generating vibrations at frequency multiples and using musical relationships such as thirds, fifths, and/or sevenths. In some embodiments, the operational routine 700 controls the banks 510-540 of tactile transducers 160 to generate, e.g., four resonant frequencies forming a harmonic chord based on a fundamental resonant frequency of the system. In block 775, the operational routine 700 applies modes of vibration to the system, providing a cymatic experience to the person on the platform 150.

The operational routine 700 ends in ending block 799.

Alternative implementations of the operational routine 700 can perform routines having processes in a different order, and some processes or blocks can be deleted, moved, added, subdivided, combined, and/or modified to provide alternative or sub combinations. Each of these processes or blocks can be implemented in a variety of different ways. While some processes or blocks may be shown as being performed in series, they may instead be performed or implemented in parallel, or can be performed at different times.

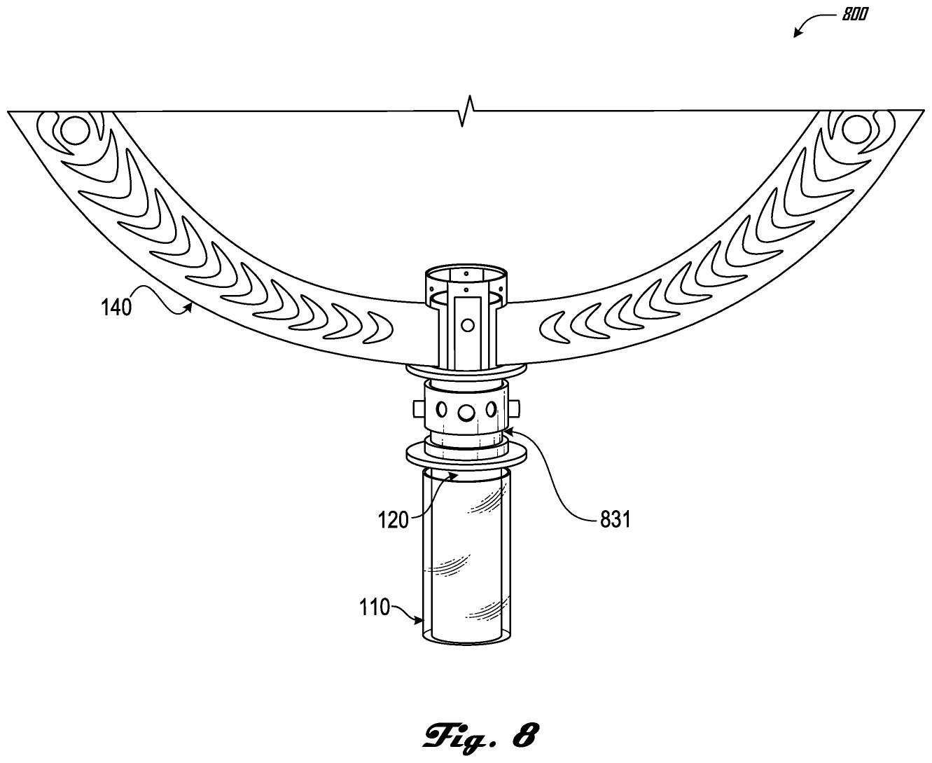

FIG. 8 schematically illustrates components of a bottom connection joint in accordance with one embodiment. The illustrated components include a base 110, a mount 120 including a pole stub that fits into the base 110, a hub 130 having a belt guide 831 for being driven by a motor, and frame members 140. The bottom connection joint connects the frame members 140 to each other and through the mount 120 to the base 110 to securely support the vibroacoustic therapy apparatus. A disk that is attached to or part of the mount 120 allows the frame members to be easily aligned and can support weight of the vibroacoustic therapy apparatus 100 In the illustrated embodiment, an end of each frame member 140 includes a quadrant of a sleeve or other connection that allows the frame members 140 to be secured to each other and to the mount 120, such as by being bolted together.

FIG. 9 illustrates components of a bottom connection joint in accordance with one embodiment. The illustrated components include a base 110 and a hub 130 having a belt guide 831 for a belt 915 being driven by a motor 910. The motor 910 spins the hub 130 to rotate the rotatable arms 135 (not attached to the hub 130 in this photograph).

FIG. 10 schematically illustrates components of a top connection joint in accordance with one embodiment. The illustrated components include frame members 140 that are connected to quarter-sections of a tube. The tube forms a top mount 122 to support a top hub 132 at the top of the vibroacoustic therapy apparatus. In the illustrated embodiment, similar to the bottom connection joint discussed above with reference to FIG. 8, an end of each frame member 140 includes a quadrant of a sleeve or other connection that allows the frame members 140 to be secured to each other. In this top connection joint embodiment, to leave the top mount 122 unobstructed for the top hub 132 to rotate, the quadrants or ends of the frame members 140 are fastened (e.g., bolted together) via external tabs or other interlocking means, shown here below the top mount 122.

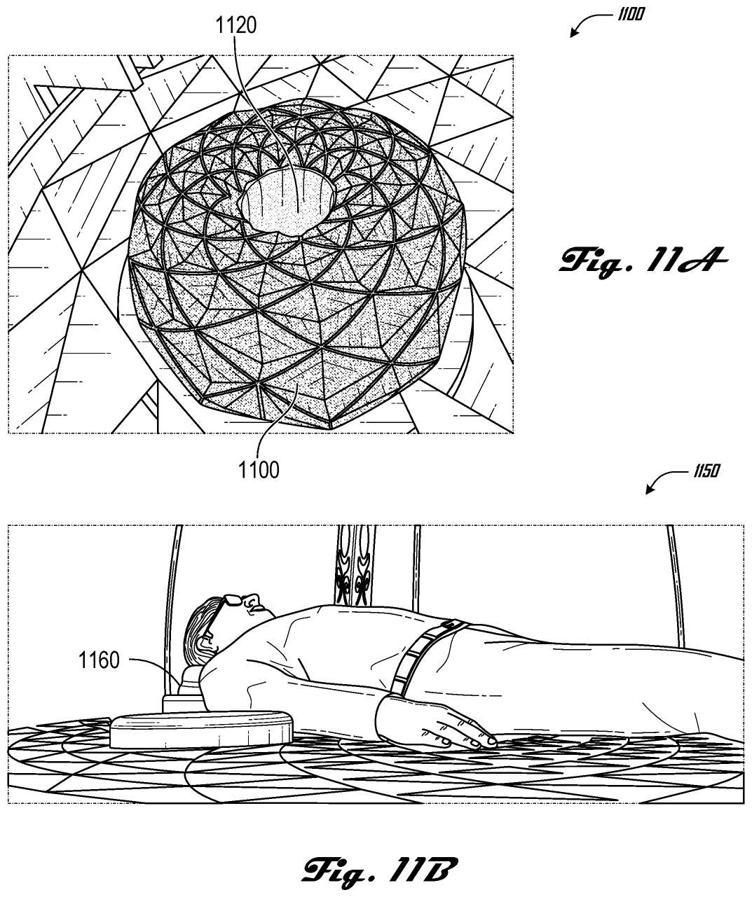

FIGS. 11A-11B illustrate aspects of silicone body pads 180 in accordance with one embodiment.

FIG. 11A illustrates a silicone body pad 180 molded to include a spiral ridged pattern 1110 and a central space 1120. The molded spiral ridged pattern 1110 provides a softer initial feel for resting a body part such as a head or neck, and improved tactile sensation for resting a body part such as a hand. The central space 1120 can accommodate a head or other body part with improved comfort.

FIG. 11B illustrates a silicone body pads 180 of different sizes and shapes, including two silicone body pads 180 stacked 1160 for increased comfort of a person's head.

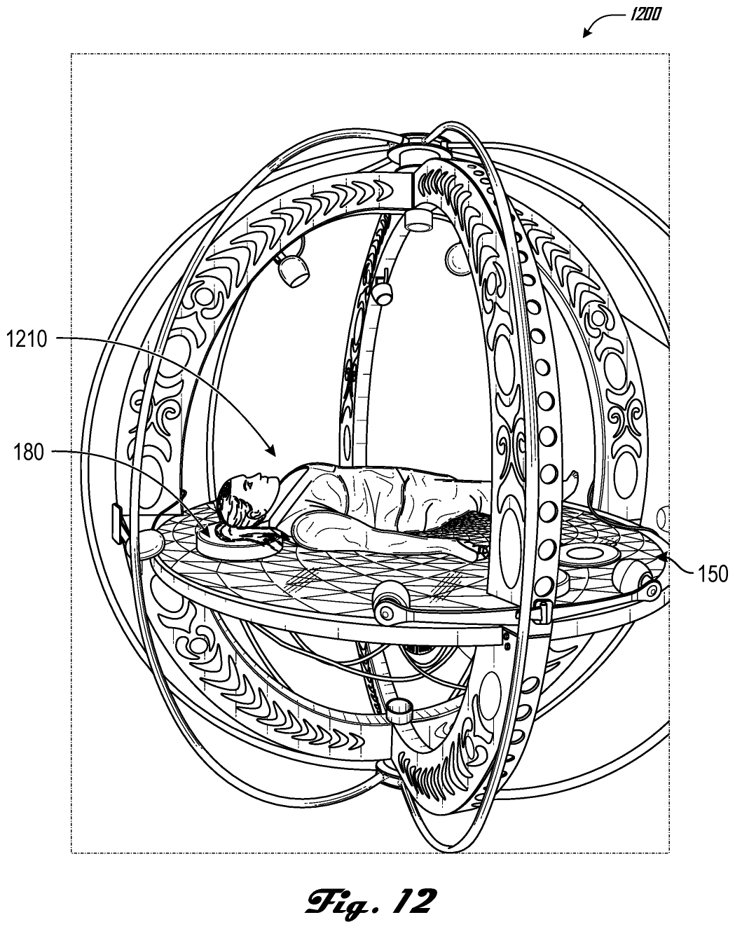

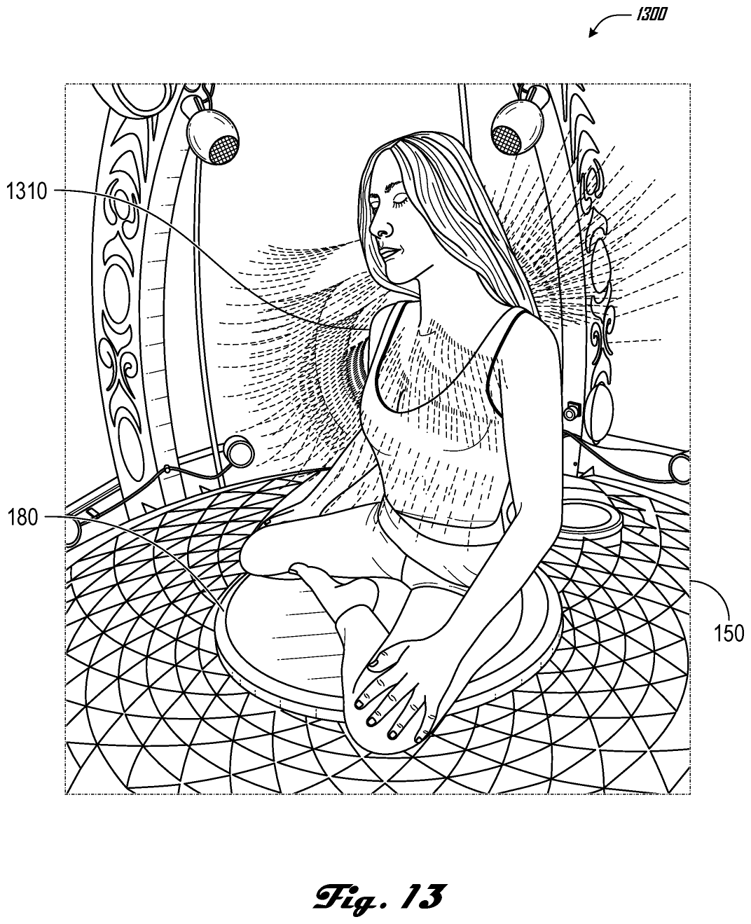

FIG. 12 illustrates a perspective view of a person 1210 lying down on a vibroacoustic therapy apparatus 1200 in accordance with one embodiment. The vibroacoustic therapy apparatus 1200 is sized suitably to allow a person to rest prone on the platform 150 and one or more silicone body pads 180. A body lying prone on the platform 150 is in the closest possible contact with the platform 150. Accordingly, a person lying down experiences cymatic effects most intensely. In addition, a body lying on the platform 150 has the largest area or portion of the body in contact with the platform 150. Accordingly, a person lying down experiences a largest variety of cymatic effects over the body, because the body may extend across different nodes of vibration.

FIG. 13 illustrates a perspective view of a person 1310 sitting upright on a vibroacoustic therapy apparatus 1300 in accordance with one embodiment. The person 130 sits (in a yoga position) on a body pad 180 on the platform 150 of the vibroacoustic therapy apparatus 1300. Sitting in the center of the vibroacoustic therapy apparatus 1300 allows the body to absorb the resonances focused at the center of the platform 150, which can be the highest-amplitude cymatic effects. In addition, the upright spine is then in alignment with the direction of greatest vibration. The illustrated silicone body pad 180 is configured to be wide enough to support a person's hips and/or knees when sitting on the body pad 180 on the platform 180.

FIG. 14 illustrates a workstation 1400 configured to operate a vibroacoustic therapy apparatus in accordance with one embodiment. The illustrated workstation 1400 includes a digital audio workstation (DAW) 1410 including a computing device (e.g., computer system 1500, discussed below with reference to FIG. 15) running live audio generation software such as Ableton Live™, a MIDI controller such as Ableton Push® 2 1420 and an amplifier 1430 that drives the tactile transducers 160. The amplifier 1430 (e.g., one or more JBL® DSi 2.0 series MA4-US amplifiers) is selected and configured to provide sufficient power—e.g., several thousand watts—to drive the tactile transducers 160 with enough energy to produce the vibrational effects disclosed herein. In some embodiments, the workstation 1400 provides independent control of each of the banks 510-540 of tactile transducers 160. Control can include separate and/or associated adjustment for each bank 510, 520, 530, 540 of frequency, amplitude, wave type or shape (e.g., sine, square, triangle, etc., including complex shapes), phase shift between different banks 510-540 (e.g., a 90 degree phase shift from the transducers of one bank to another bank), low-frequency oscillation (LFO) type and rate, etc.

The illustrated workstation 1400 allows an operator to control the banks 510-540 of tactile transducers 160 to produce cymatic effects in the vibratory system including the platform 150 of the vibroacoustic therapy apparatus 100 and a body on the platform 150, such as discussed above with reference to FIG. 7.

In some embodiments, the workstation 1400 allows an operator to tune the vibroacoustic therapy apparatus to resonate a portion of a body, such as a skeleton or musculature. The targeted body portion may be an organ or a group of organs, or a resonant cavity within a human body, which can come into sympathetic vibration with the Sonosphere as an instrument.

In addition, the workstation 1400 allows an operator to provide broader stimulation of the senses while applying cymatic resonant frequencies to the human body. The workstation 1400 allows the operator to add layers to create immersive art experiences through the speakers 170 and lighting effects.

FIG. 15 is a block diagram showing some of the components typically incorporated in computing systems and other devices in connection with which the present technology can be implemented. The computer system 1500 may include a subset or superset of the components described herein. In the illustrated embodiment, the computer system 1500 includes a processing component 1530 that controls operation of the computer system 1500 in accordance with computer-readable instructions stored in memory 1540. The processing component 1530 may be any logic processing unit, such as one or more central processing units (CPUs), graphics processing units (GPUs), digital signal processors (DSPs), field-programmable gate arrays (FPGAs), application-specific integrated circuits (ASICs), etc. The processing component 1530 may be a single processing unit or multiple processing units in an electronic device or distributed across multiple devices. Aspects of the present technology can be embodied in a special purpose computing device or data processor that is specifically programmed, configured, or constructed to perform one or more of the computer-executable instructions explained in detail herein.

Aspects of the present technology can also be practiced in distributed computing environments in which functions or modules are performed by remote processing devices that are linked through a communications network, such as a local area network (LAN), wide area network (WAN), or the Internet. In a distributed computing environment, modules can be located in both local and remote memory storage devices. In various embodiments, the computer system 1500 may comprise one or more physical and/or logical devices that collectively provide the functionalities described herein. In some embodiments, the computer system 1500 may comprise one or more replicated and/or distributed physical or logical devices. In some embodiments, the computer system 1500 may comprise one or more computing resources provisioned from a “cloud computing” provider, for example, Amazon® Elastic Compute Cloud (“Amazon EC2®”), Amazon Web Services® (“AWS”), and/or Amazon Simple Storage Service™ (“Amazon S3™”), provided by Amazon.com, Inc. of Seattle, Washington; Google Cloud Platform™ and/or Google Cloud Storage™, provided by Google Inc. of Mountain View, California; Windows Azure, provided by Microsoft Corporation of Redmond, Washington; and the like.

The processing component 1530 is connected to memory 1540, which can include a combination of temporary and/or permanent storage, and both read-only memory (ROM) and writable memory (e.g., random access memory (RAM), processor registers, and on-chip cache memories), writable non-volatile memory such as flash memory or other solid-state memory or solid-state disks (SSDs), hard drives, removable media, magnetically or optically readable discs and/or tapes, nanotechnology memory, synthetic biological memory, and so forth. A memory is not a propagating signal divorced from underlying hardware; thus, a memory and a computer-readable storage medium do not refer to a transitory propagating signal per se. The memory 1540 includes data storage that contains programs, software, and information, such as an operating system 1542, application programs 1544, and data 1546. Computer system 1500 operating systems 1542 can include, for example, Windows Linux®, Android™, iOSx, Chrome OS™, middleware, and/or an embedded real-time operating system. The application programs 1544 and data 1546 can include software and data-including data structures, database records, etc.—configured to control computer system 1500 components, process information (to, e.g., optimize vibrations for a body), communicate and exchange data and information with remote computers and other devices, etc.

The computer system 1500 can include input components 1510 that receive input from user interactions and provide input to the processor 1530, typically mediated by a hardware controller that interprets the raw signals received from the input device and communicates the information to the processor 1530 using a known communication protocol. Examples of an input component 1510 include a keyboard 1512 (with physical or virtual keys), a pointing device (such as a mouse 1514, joystick, dial, or eye tracking device), a touchscreen 1515 that detects contact events when it is touched by a user, a microphone 1516 that receives audio input, and a camera 1518 for still photograph and/or video capture. The computer system 1500 can also include various other input components 1510 such as GPS or other location determination sensors, motion sensors, wearable input devices with accelerometers (e.g., wearable glove-type input devices), biometric sensors (e.g., a fingerprint sensor), light sensors (e.g., an infrared sensor), card readers (e.g., a magnetic stripe reader or a memory card reader), and so on.

The processor 1530 can also be connected to one or more various output components 1520, e.g., directly or via a hardware controller. The output devices can include a display 1522 on which text and graphics are displayed. The display 1522 can be, for example, an LCD, LED, or OLED display screen (such as a desktop computer screen, handheld device screen, or television screen), an e-ink display, a projected display (such as a heads-up display device), and/or a display integrated with a touchscreen 1515 that serves as an input device as well as an output device that provides graphical and textual visual feedback to the user. The output devices can also include a speaker 1524 for playing audio signals, haptic feedback devices for tactile output such as vibration, etc. In some implementations, the speaker 1524 and the microphone 1516 are implemented by a combined audio input-output device.

In the illustrated embodiment, the computer system 1500 further includes one or more communication components 1550. The communication components can include, for example, a wired network connection 1552 (e.g., one or more of an Ethernet port, cable modem, Thunderbolt cable, FireWire cable, Lightning connector, universal serial bus (USB) port, etc.) and/or a wireless transceiver 1554 (e.g., one or more of a Wi-Fi transceiver; Bluetooth transceiver; near-field communication (NFC) device; wireless modem or cellular radio utilizing GSM, CDMA, 3G, 4G, and/or 5G technologies; etc.). The communication components 1550 are suitable for communication between the computer system 1500 and other local and/or remote computing devices, directly via a wired or wireless peer-to-peer connection and/or indirectly via a communication link and networking hardware, such as switches, routers, repeaters, electrical cables and optical fibers, light emitters and receivers, radio transmitters and receivers, and the like (which can include the Internet, a public or private intranet, a local or extended Wi-Fi network, cell towers, the plain old telephone system (POTS), etc.). The computer system 1500 further includes power 1560, which can include a stored energy system such as a capacitor or battery; an external power supply such as a direct current (DC) voltage source; or a connection to an alternating current (AC) conductor for operation of the various electrical components associated with the computer system 1500.

Examples of well-known computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like. While computer systems configured as described above are typically used to support the operation of the technology, one of ordinary skill in the art will appreciate that the technology may be implemented using devices of various types and configurations, and having various components. Alternative implementations of the systems disclosed herein can employ systems having blocks arranged in different ways; and some blocks can be deleted, moved, added, subdivided, combined, and/or modified to provide alternative or sub combinations. Each of these blocks can be implemented in a variety of different ways. However, it is not necessary to show such infrastructure and implementation details or variations to describe an illustrative embodiment.

Although specific embodiments have been illustrated and described herein, it will be appreciated by those of ordinary skill in the art that alternate and/or equivalent implementations may be substituted for the specific embodiments shown and described without departing from the scope of the present disclosure. For example, although various embodiments are described above in terms of a housing that snaps around a conductor or a flexible sensing attachment that wraps around a conductor, in other embodiments various other form factors may be used. In addition, processing and/or output readings may be provided locally at the apparatus and/or performed or displayed remotely. The spirit and scope of this application is intended to cover any adaptations or variations of the embodiments discussed herein.

Thus, although the subject matter has been described in language specific to structural features and/or methodological acts, it is also to be understood that the subject matter defined in the appended claims is not necessarily limited to the specific features or acts described. Rather, the specific features and acts are disclosed as example forms of implementing the claims. This application is intended to cover any adaptations or variations of the embodiments discussed herein.

Example 1: A vibroacoustic therapy device as disclosed and illustrated herein.

Example 2: The vibroacoustic therapy device of Example 1, wherein a substantially circular platform is supported only at edges of the platform.

Example 3: The vibroacoustic therapy device of Example 2, wherein tactile transducers are mounted beneath the platform in an evenly spaced geometric relationship around the center of the platform.

Example 4: The vibroacoustic therapy device of Example 1, including a rotating sphere.

Example 5: A method of tuning or calibrating a vibroacoustic therapy device as disclosed and illustrated herein.

Example 6: A method of producing cymatic resonance in a body using a vibroacoustic therapy device as disclosed and illustrated herein.

What is claimed is:

1. A vibroacoustic therapy apparatus comprising:
a platform having a curved plan shape, configured to support a human body and to vibrate in response to applied vibroacoustic waves, such that the platform passes vibrations into the human body,
wherein at least part of the vibroacoustic therapy apparatus including the platform is configured to form, together with the human body, a vibratory system of resonance;
a plurality of tactile transducers affixed to the platform, wherein the tactile transducers are configured to induce vibrations in the platform at frequencies that resonate with the vibratory system of resonance;
wherein the tactile transducers are configured to create internal areas of increased vibratory sensation within the human body to produce cymatic sensations when the apparatus is in operation.

2. The vibroacoustic therapy apparatus of claim 1 wherein the platform is substantially circular and supported only at edges of the platform.

3. The vibroacoustic therapy apparatus of claim 1 wherein the platform is not rigidly fastened to other parts of the vibroacoustic therapy device and can freely vibrate in different natural or cymatic modes and produce varying internal physical sensations that can be customized for the human body in contact with the platform.

4. The vibroacoustic therapy apparatus of claim 1 wherein the platform is formed of or constructed from acrylic that is approximately one inch thick and has a height and width sufficient to support the human body lying prone on the platform.

5. The vibroacoustic therapy apparatus of claim 2 wherein the tactile transducers are arranged in an evenly spaced geometric relationship around the center of the platform.

6. The vibroacoustic therapy apparatus of claim 5 wherein positions of the tactile transducers around the platform are laid out symmetrically about at least one axis.

7. The vibroacoustic therapy apparatus of claim 5 wherein the tactile transducers are arranged in a triangular, hexagonal, octagonal, or other polygonal relationship to each other, wherein a spacing between each tactile transducer is related to a diameter of the platform by a ratio or fractional multiple composed of whole integers.

8. The vibroacoustic therapy apparatus of claim 1 wherein the vibratory system of resonance is configured to have a fundamental frequency of around 37-42 Hz.

9. The vibroacoustic therapy apparatus of claim 1, further comprising rotatable elements configured to spin around the platform, wherein when in rotation, the rotatable elements approximate a sphere.

10. The vibroacoustic therapy apparatus of claim 9 wherein the rotatable elements provide an additional layer of overtone harmonics to amplify sounds within the approximated sphere or on the platform.

11. The vibroacoustic therapy apparatus of claim 1, further comprising a silicone body pad configured to provide comfort for a person using the apparatus and to transmit the vibrations in the platform to the person using the apparatus.

12. The vibroacoustic therapy apparatus of claim 1, further comprising a heat source configured to warm the platform or a body pad prior to use, to improve comfort for a person using the apparatus.

13. The vibroacoustic therapy apparatus of claim 1, further comprising a workstation including a computer system configured to control an amplitude, a frequency, a wave type or shape, or a phase of one or more of the tactile transducers to produce the cymatic sensations within the human body when the apparatus is in operation.

14. The vibroacoustic therapy apparatus of claim 13, wherein the computing device is configured to control sets or banks of the tactile transducers.

15. The vibroacoustic therapy apparatus of claim 1, further comprising one or more audio speakers that generate sound at frequencies predominantly perceived audibly, to enhance and complement the vibroacoustic sensations generated by the tactile transducers.

16. A method for tuning or calibrating a vibroacoustic therapy apparatus, the method comprising:
either:
determining an initial mass of a vibratory system of the vibroacoustic therapy apparatus, wherein the vibratory system includes a platform configured to support a human body and to vibrate in response to applied vibroacoustic waves;
determining an updated mass of the vibratory system including a human body on the platform; and
calculating an adjusted resonance based on the updated mass of the vibratory system including the human body;
or:
arranging a person in a desired position on the platform of the vibroacoustic therapy apparatus so that the vibratory system includes the human body on the platform;
generating a sweep of frequencies via a tactile transducer affixed to the platform;
sensing a response to the sweep of frequencies; and
analyzing the sensed response to the sweep of frequencies to determine a fundamental frequency of the vibratory system.
and:
calculating additional frequencies to produce cymatic sensations in the human body based on the adjusted resonance and/or the fundamental frequency, including modes of the adjusted resonance or fundamental frequency.

17. The method for tuning or calibrating a vibroacoustic therapy apparatus of claim 16, wherein generating the sweep of frequencies produces tones above 15 Hz and below 100 Hz, and wherein sensing a response to the sweep of frequencies includes detecting, via an accelerometer or a microphone, an amplitude of vibrations of the vibratory system including the human body, and wherein analyzing the sensed response to the sweep of frequencies includes identifying a frequency at which the amplitude of vibrations of the vibratory system including the human body is increased or highest.

18. The method for tuning or calibrating a vibroacoustic therapy apparatus of claim 16, further comprising applying vibroacoustic energy at frequencies that resonate with the vibratory system including the human body, including the additional frequencies, to induce cymatic sensations within the human body.

19. A method for producing cymatic resonance in a human body, the method comprising:
arranging the human body on a vibroacoustic therapy apparatus, the vibroacoustic therapy apparatus comprising:
a platform having a curved plan shape, configured to support the human body and to freely vibrate in response to applied vibroacoustic waves, such that the platform passes vibrations into the human body,
wherein at least part of the vibroacoustic therapy apparatus including the platform is configured to form, together with the human body, a vibratory system of resonance; and
a plurality of tactile transducers affixed to the platform, wherein the tactile transducers are configured to induce vibrations in the platform at frequencies that resonate with the vibratory system of resonance;
causing the tactile transducers to vibrate;
controlling the tactile transducers to apply vibroacoustic energy at frequencies that resonate with the vibratory system of resonance, and to create internal areas of increased vibratory sensation within the human body that produce cymatic sensations.

20. The method for producing cymatic resonance in a human body of claim 19, further comprising tuning or calibrating the vibroacoustic therapy apparatus to the individual human body on the vibroacoustic therapy apparatus, such that the vibroacoustic therapy apparatus resonates the human body and applies vibroacoustic energy at different frequencies, inducing sensations of vibrational patterns within the human body.
